(19) United States
(12) Patent Application Publication
(10) Pub. No.: US 2017/0109725 A1
(43) Pub. Date: Apr. 20, 2017

(54) MOBILE TERMINAL AND OPERATION METHOD THEREOF

(71) Applicant: LG ELECTRONICS INC., Seoul (KR)

(72) Inventor: Jaebeom JEON, Seoul (KR)

(73) Assignee: LG Electronics Inc.

(21) Appl. No.: 15/134,159

(22) Filed: Apr. 20, 2016

(30) Foreign Application Priority Data
Oct. 19, 2015 (KR) 10-2015-0145653

(51) Int. Cl. G06Q 20/32; G06Q 20/40; G06Q 20/38

(52) U.S. Cl. CPC G06Q 20/3224; G06Q 20/325; G06Q 20/382; G06Q 20/40

(57) ABSTRACT

A mobile terminal is provided. The mobile terminal includes a display unit, a wireless communication unit to exchange information on payment for a product with a payment terminal, a memory to store the information on the payment, and a control unit coupled with the display unit, the wireless communication unit and the memory, wherein the control unit is further capable of: displaying information for indicating completion of payment authentication for the product, if a condition corresponding to easy payment information comprising a time range and a location range.

### CROSS-REFERENCE TO RELATED APPLICATION

The present application claims priority under 35 U.S.C. 119 and 35 U.S.C. 365 to Korean Patent Application No. 10-2015-0145653 (filed on Oct. 19, 2015), which is hereby incorporated by reference in its entirety.

### BACKGROUND

1. Field

The present disclosure relates to a mobile terminal and an operation method thereof and more particularly, to a mobile terminal and an operation method thereof capable of allowing a user to easily pay in a shop frequently visited by the user without additional authentication.

2. Background

Terminals can be divided into mobile/portable terminals or stationary terminals according to whether to be portable. The mobile terminals can be divided again into handheld terminals and vehicle mounted terminals whether to be directly portable by the user.

Functions of a mobile terminal become diversified. For example, there are functions of data and voice communication, image and video capturing through a camera, voice recording, music file playback through a speaker system, and outputting an image or a video on a display unit. Some terminals have an additional electronic game play function or perform a multimedia player function. In particular, mobile terminals nowadays can receive a broadcasting signal or a multicast signal providing visual content such as a video or a television program.

According to diversification of functions, such a terminal is implemented in a multimedia player type having complex functions therein, for example, image or video capturing, playback of a music or video file, a game, and broadcast reception.

Recently various technologies are emerged for paying for products through a mobile terminal. The payment through a mobile terminal requires an additional authentication process such as an input of a user's fingerprint or password. For the payment through fingerprint recognition, a process thereof is cumbersome and a malfunction can occur.

### BRIEF DESCRIPTION OF THE DRAWINGS

The embodiments will be described in detail with reference to the following drawings in which like reference numerals refer to like elements wherein:

FIG. 1 is a block diagram for explaining a mobile terminal related to an embodiment;

FIG. 2 is a flowchart illustrating an operation method of a mobile terminal according to an embodiment;

FIG. 3 illustrates a state where product payment is performed by using a mobile terminal according to an embodiment;

FIG. 4 illustrates a process for receiving a request for generating an easy payment pattern according to an embodiment;

FIGS. 5 to 10 illustrate examples for generating an easy payment setting window and generating an easy payment pattern through the easy payment setting window according to an embodiment;

FIG. 11 illustrates that payment authentication is completed if an easy payment condition is satisfied according to an embodiment; and

FIG. 12 illustrates a process for receiving an input corresponding to a security level set for easy payment according to an embodiment.

### DETAILED DESCRIPTION

Reference will now be made in detail to the embodiments of the present disclosure, examples of which are illustrated in the accompanying drawings, in which like numbers refer to like elements throughout, and a repetitive explanation will be omitted. In the following description, usage of suffixes such as ‘module’, ‘part’ or ‘unit’ used for referring to elements is given merely to facilitate explanation of the present invention, without having any significant meaning by itself. In the following description, detailed descriptions of well-known functions or constructions will be omitted since they would obscure the invention in unnecessary detail. In addition, the accompanying drawings are used to help easily understand the technical idea of the present invention and it should be understood that the idea of the present invention is not limited by the accompanying drawings. However, this invention should not be construed as limited to specific disclosure forms, and the spirit and scope of the invention should be understood as incorporating various modifications, equivalents and substitutions.

It will be understood that, although the terms first, second, etc., can be used herein to distinguish one element from another element, not to be limited by the terms.

It will be understood that if an element is referred to as being “connected” or “coupled” to another element, it can be directly connected or coupled to the other element or intervening elements can be present. In contrast, if an element is referred to as being “directly connected” or “directly coupled” to another element, there are no intervening elements present.

As used herein, the singular forms “a,” “an” and “the” are intended to include the plural forms as well, unless the context clearly indicates otherwise.

It will be further understood that the terms “comprises” and/or “comprising,” if used in this specification, specify the presence of stated features, integers, steps, operations, elements, and/or components, but do not preclude the presence or addition of one or more other features, integers, steps, operations, elements, components, and/or groups thereof.

A mobile terminal described herein can include a mobile phone, a smart phone, a laptop computer, a digital broadcast terminal, a personal digital assistants (PDA), a portable multimedia player (PMP), a navigator, a slate PC, a tablet PC, an ultrabook, a wearable device (for example, a smart watch, a smart glass, or a head mounted display (HMD)).

However, those skilled in the art can easily understand that a configuration according to embodiments described herein can also be applied a stationary terminal such as a digital TV, a desktop computer, or a digital signage, except a case of being applied only to a mobile terminal.

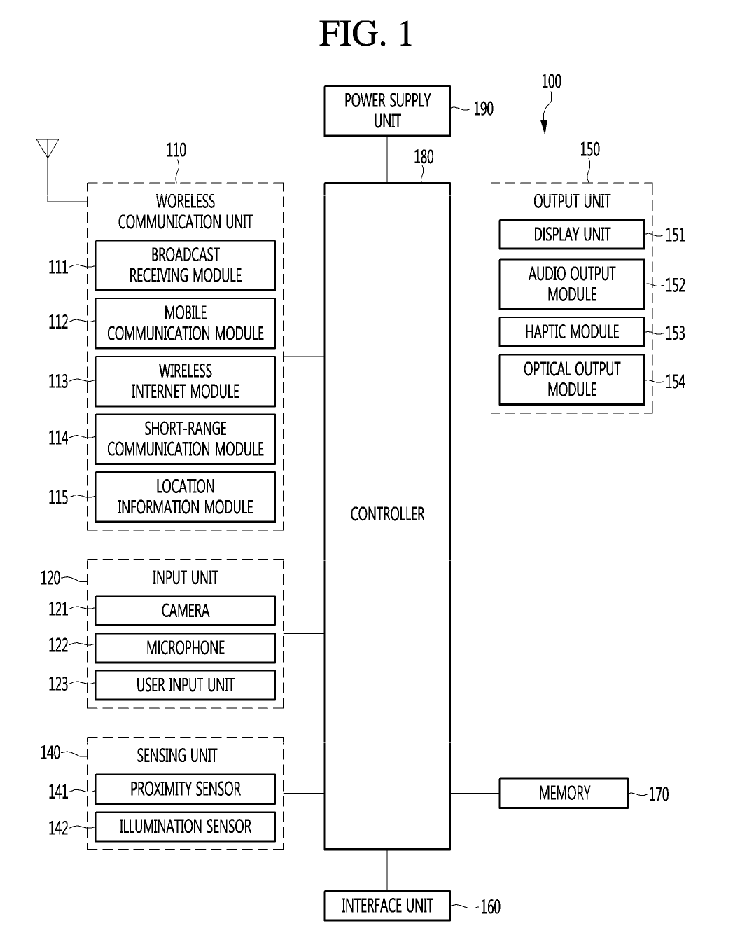

FIG. 1 is a block diagram for explaining a mobile terminal in relation to an embodiment.

The mobile terminal 100 can include a wireless communication unit 110, an input unit 120, a sensing unit 140, an output unit 150, an interface unit 160, a memory unit 170, a control unit 180, and a power supply unit 190. Since the elements illustrated in FIG. 1 are not essential for realizing a mobile terminal, a mobile terminal to be described herein can include more or fewer elements than the above-described.

In detail, the wireless communication unit 110 among the elements can include one or more modules for enabling wireless communication between the mobile terminal 100 and another mobile terminal 100, or between the mobile terminal 100 and an external server. In addition, the wireless communication 110 can include one or more modules for connecting the mobile terminal 100 to one or more networks.

The wireless communication unit 110 can include at least one of a broadcast reception module 111, a mobile communication module 112, a wireless internet module 113, a short range communication module 114, and a location information module 115.

The input unit 130 can include a camera 121 or an image input unit for an image signal input, a microphone 122 or an audio input unit for an audio signal input, a user input unit 123 (e.g. a touch key, a mechanical key, etc.) for receiving information from a user. Voice data or image data collected by the input unit 120 can be analyzed and processed with user's control commands.

The sensing unit 140 can include at least one sensor for sensing at least one of surrounding environment information around the mobile terminal and user information. For example, the sensing unit 140 can include at least one selected from a proximity sensor 141, an illumination sensor 142, a touch sensor, an acceleration sensor, a magnetic sensor, a G-sensor, a gyroscope sensor, a motion sensor, an RGB sensor, an infrared (IR) sensor, a finger scan sensor, an ultrasonic sensor, an optical sensor (e.g., the camera (see 121)), a microphone (see 122), a battery gauge, an environmental sensor (e.g., a barometer, a hygrometer, a thermometer, a radiation sensor, a thermal sensor, a gas detection sensor, etc.), a chemical sensor (e.g., an e-nose, a healthcare sensor, a biometric sensor, etc.). Furthermore, the mobile terminal disclosed herein can combine and use information sensed by at least two sensors among those sensors.

The output unit 150 is for generating an output related to sense of sight, sense of hearing, or sense of touch, and can include at least one selected from a display unit 151, an audio output unit 152, a haptic module 153, and a light output unit 154. The display unit 151 can form a mutually layered structure with or be formed into one with a touch sensor, and realize a touch screen. Such a touch screen can function as the user input unit 123, which provides an input interface between the mobile terminal 100 and the user, and at the same time, can provide an output interface between the mobile terminal 100 and the user.

The interface unit 160 plays a role of a passage with various kinds of external devices connected to the mobile terminal 100. This interface unit 160 can include at least one selected from a wired/wireless headset port, an external charger port, a wired/wireless data port, a memory card port, a port connecting a device having an identification module provided therein, an audio input/output (I/O) port, a video input/output (I/O) port, and an earphone port. In the mobile terminal 100, a proper control can be performed on a connected external device in correspondence to connection between the external device and the interface unit 160.

In addition, the memory 170 stores data for supporting various functions of the mobile terminal 100. The memory 170 can store a plurality of application programs or applications driven in the mobile terminal 100, data for operations of the mobile terminal 100, and instructions. At least some of these application programs can be downloaded from an external server through wireless communication. In addition, some of these application programs can exist in the mobile terminal 100 from the time of release for basic functions (e.g. a call originating or receiving function, a message transmitting and receiving function). Moreover, the application programs are stored in the memory 170 and installed in the mobile terminal 100, and then can be driven to perform operations (or functions) of the mobile terminal by the control unit 180.

The control unit 180 typically controls overall operations of the mobile terminal 100 besides operations related to the application programs. The control unit 180 can provide the user with, or process proper information or functions by processing a signal, data, or information input or output through the above-described elements or by driving the application programs stored in the memory 170.

In addition, the control unit 180 can control at least a part of the elements illustrated in FIG. 1 so as to drive the application programs stored in the memory 170. Furthermore, the control unit 180 can combine at least two elements among the elements included in the mobile terminal 100 and operate the combined.

The power supply unit 190 receives internal or external power under a control of the control unit 180 and supplies the power to each element included in the mobile terminal 100. The power supply unit 190 includes a battery and the battery can be an embedded type or a replaceable type.

At least a part of the elements can operate in cooperation with each other for realizing an operation, control, or control method of the mobile terminal according to various embodiments. In addition, the operation, control, or control method of the mobile terminal can be realized in the mobile terminal by driving at least one application program stored in the memory 170.

Hereinafter, the above-described elements are described in detail with reference to FIG. 1 before describing various embodiments realized through the mobile terminal 100.

Firstly, in the wireless communication unit 110, the broadcast reception module 111 receives a broadcast signal and/or broadcast related information from an external broadcast management server through a broadcast channel. The broadcast channel can include a satellite channel or a terrestrial channel. Two or more broadcast reception modules can be provided to the mobile terminal 100 for simultaneous broadcast reception or broadcast channel switching for at least two broadcast channels.

The mobile communication module 112 can transmit and receive wireless signals to and from at least one selected from a base station, an external terminal, and a server on a mobile communication network constructed according to technical standards or communication schemes for the mobile communication (e.g., Global System for Mobile communication (GSM), Code Division Multi Access (CDMA), Code Division Multi Access 2000 (CDMA 2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), and Long Term Evolution-Advanced (LTE-A) etc.).

The wireless signal can include a voice call signal, a video call signal, or various types of data according to transmission and reception of a text/multimedia message.

The wireless internet module 113 refers to a module for a wireless internet connection, and can be embedded in or provided outside the mobile terminal 100. The wireless internet module 113 is configured to transmit and receive a wireless signal over a communication network conforming to wireless internet technologies.

The wireless internet technologies include, for example, Wireless LAN (WLAN), Wireless-Fidelity (Wi-Fi), Wi-Fi Direct, Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), Long Term Evolution (LTE), and LTE-Advanced (LTE-A), and the wireless internet module 113 transmits and receives data according to at least one wireless internet technology within the range of including internet technology not described in the above.

From a viewpoint that an access to the wireless internet through WiBro, HSDPA, HSUPA, GSM, CDMA, WCDMA, LTE, or LTE-A is conducted through a mobile communication network, the wireless internet module 113 conducting the access to the wireless internet through the mobile communication network can be understood as a kind of the mobile communication module 112.

The short range communication module 114 is for short range communication and can support the short range communication by using at least one selected from Bluetooth™, Radio Frequency Identification (RFID), Infrared Data Association (IrDA), Ultra Wideband UWB), ZigBee, Near Field Communication (NFC), Wi-Fi, Wi-Fi Direct, and Wireless Universal Serial Bus (Wireless USB) technologies. This short range communication module 114 can support, through a wireless area network, wireless communication between the mobile communication terminal 100 and a wireless communication system, between the mobile terminal 100 and another mobile terminal 100, or between the mobile terminal 100 and a network on which the other mobile terminal 100 or an external server is located. The wireless area network can be a wireless personal area network.

Here, the other mobile terminal 100 can be a wearable device (e.g., a smart watch, a smart glass, or an HMD) through which data is mutually exchangeable (or interlockable) with the mobile terminal 100 according to an embodiment. The short range communication module 114 can detect (or recognize) a wearable device capable of communicating with the mobile terminal 100. Furthermore, if the detected wearable device is authenticated to communicate with the mobile terminal 100, the control unit 180 can transmit at least a part of data processed in the mobile terminal 100 to the wearable device through the short range communication module 114. Therefore, a user of the wearable device can use the data processed by the mobile terminal 100 through the wearable device. For example, if a call is received by the mobile terminal 100, the user can perform a phone call through the wearable device, or if a message is received by the mobile terminal 100, the user can check the received message through the wearable device.

The location information module 115 is for obtaining a location (or a current location) of the mobile terminal. As a representative example thereof, there is a global positioning system (GPS) module or a Wi-Fi module. For example, if adopting the GPS module, the mobile terminal can obtain a location of the mobile terminal by using a signal transmitted from a GPS satellite. For another example, if adopting the Wi-Fi module, the mobile terminal can obtain the location of the mobile terminal on the basis of information on a wireless access point (AP) transmitting or receiving a wireless signal with the Wi-Fi module. If necessary, the location information module 115 can additionally or alternatively perform any one function among other modules in the wireless communication unit 110 in order to obtain data about the location of the mobile terminal. The location information module 115 is a module used for obtaining the location (or current location) of the mobile terminal, and is not limited to a module directly calculating or obtaining the location of the mobile terminal.

Next, the input unit 120 is for receiving image information (or an image signal), audio information (or an audio signal), data, or information input from the user. The mobile terminal 100 can include one or a plurality of cameras 121 for an input of image information. The camera 121 processes an image frame such as a still image or video obtained by an image sensor in a video call mode or an image capturing mode. The processed image frame can be displayed on the display unit 151 or stored in the memory 170. Furthermore, the plurality of cameras 121 provided in the mobile terminal 100 can be arranged to form a matrix structure, and, through the cameras 121 forming this matrix structure, a plurality of pieces of information on images having different angles or different focuses can be input to the mobile terminal 100. In addition, the plurality of cameras 121 can be arranged in a stereo structure to obtain left and right images for realizing a stereoscopic image.

The microphone 122 can process an external sound signal as electrical voice data. The processed voice data can be diversely used according to a function (or an application program) being performed in the mobile terminal 100. Furthermore, various noise removal algorithms can be implemented for removing noise generated in a process for receiving the external sound signal.

The user input unit 123 is for receiving information from the user. If information is input through the user input unit 123, the control unit 180 can control an operation of the mobile terminal 100 in correspondence to the input information. This user input unit 123 can include a mechanical input unit (or mechanical key, for example, buttons positioned on the front and rear surfaces or on the side surfaces, a dome switch, a jog wheel, or a jog switch, etc.) and a touch type input unit. As an example, the touch type input unit can be configured with a virtual key displayed on a touch screen through a software processing, a soft key, or a visual key, or a touch key disposed on a portion other than the touch screen. In addition, the virtual key or the visual key is possibly displayed on the touch screen in various types and, for example, can be configured with graphics, texts, icons, videos, or a combination thereof.

Furthermore, the sensing unit 140 can sense at least one of environmental information surrounding the mobile terminal 100 and user information, and generate a sensing signal corresponding to the sensed information. The control unit 180 can control driving or operations of the mobile terminal 100, or perform data processing, a function, or an operation related to an application program installed in the mobile terminal 100, on the basis of the sensing signal. Hereinafter, representative sensors among various sensors that can be included in the sensing unit 140 are described in detail.

Firstly, the proximity sensor 141 refers to a sensor for detecting whether an object approaches or is in the proximity of a prescribed detection surface by using an electromagnetic force or an infrared ray without a mechanical contact. This proximity sensor 141 can be disposed in an internal area of the mobile terminal surrounded by the above-described touch screen or around the touch screen.

As an example of the proximity sensor 141, there is a transmissive photoelectric sensor, directly reflective photoelectric sensor, mirror reflective optoelectronic sensor, high frequency oscillatory proximity sensor, capacitive proximity sensor, inductive proximity sensor, infrared proximity sensor, and the like. If the touch screen is capacitive type, the proximity sensor 141 can be configured to detect an access of an object having conductivity by a change of an electric field according to the access of the object. In this case, the touch screen (or a touch sensor) itself can be classified to a proximity sensor.

Hereinafter, for convenience of explanation, an action is called “proximity touch” that a pointer does not contact the touch screen but is recognized as positioned on the touch screen, and an action is called “contact touch” that the pointer actually contacts the touch screen. A position at which an object is subject to a proximity touch over the touch screen means a position at which the object vertically corresponds to the touch screen if the object is subject to the proximity touch. The proximity sensor senses a proximity touch and a proximity touch pattern (e.g., proximity distance, proximity touch direction, proximity touch speed, proximity touch time, proximity touch position, proximity movement state, and the like). Furthermore, the control unit 180 can process data (or information) corresponding to a proximity touch action and the proximity touch pattern detected through the proximity sensor 141 and, in addition, can output visual information corresponding to the processed data on the touch screen. In addition, the control unit 180 can perform a control on the mobile terminal 100 so that different operations or different data (or information) are processed according to whether a touch for an identical point on the touch screen is a proximity touch or a contact touch.

The touch sensor senses a touch (or a touch input) applied to the touch screen (or the display unit 151) by using at least one of various touch types including a resistive-film, capacitive, infrared ray, ultrasonic, and magnetic field types.

As an example, the touch sensor can be configured to convert a change in pressure applied to a prescribed part or a change in capacitance generated at a prescribed part of the touch screen into an electrical input signal. The touch sensor can be configured to detect a position or an area that is touched by a touching object, which touches the touch screen, or pressure or capacitance at the time of touching. Here, the touching object, for example, a finger, a touch pen, a stylus pen, or a pointer, can be an object applying a touch on the touch sensor.

In this way, if there is a touch input on the touch sensor, a signal (signals) corresponding thereto is (are) transmitted to a touch controller. The touch controller processes the signal(s) and transmits corresponding data to the control unit 180. Accordingly, the control unit 180 can determine which area of the display unit 151 is touched. Here, the touch controller can be a separate element other than the control unit 180, or can be the control unit itself.

Furthermore, the control unit 180 can perform different controls or an identical control according to a kind of the touch object, which touches the touch screen (or a touch key provided besides the touch screen). Whether to perform different controls or an identical control according to a kind of the touch object can be determined according to a current operation state of the mobile terminal 100 or an application program being executed.

The above-described touch sensor and proximity sensor can sense various types of touches on the touch screen independently or in a combined manner, wherein the touches include a short (or a tap) touch, a long touch, a multi-touch, a drag touch, a flick touch, a pinch-in touch, a pinch-out, a swipe touch, and a hovering touch.

The ultrasonic sensor can recognize location information on a touch object by using an ultrasonic wave. The control unit 180 can calculate a position of a wave generating source through information sensed by an optical sensor and a plurality of ultrasonic sensors. The position of the wave generating source can be calculated by using a property that a light is very faster than the ultrasonic wave, in other words, a time that a light arrives at an optical sensor is very shorter than a time that an ultrasound wave arrives at an ultrasonic sensor. In detail, with a light as a reference signal, the position of the wave generating source can be calculated by using a time difference with a time if an ultrasonic wave arrives.

Furthermore, from a view of a configuration of the input unit 120, the camera 121 includes at least one selected from a camera sensor (e.g., a CCD, or a CMOS sensor), a photo sensor (or an image sensor), and a laser sensor.

The camera 121 and the laser sensor can be combined together and sense a touch of the sensing target for a 3-dimensional stereoscopic image. The photo sensor can be stacked on a display element, and this photo sensor scans a movement of the sensing target close to the touch screen. In detail, the photo sensor includes photo diodes and transistors in rows/columns and scans a target mounted on the photo sensor by using an electrical signal changed according to an amount of a light applied to the photo diodes. In other words, the photo sensor performs coordinate calculation on the sensing target according to a change amount of the light and, through this, location information on the sensing target can be obtained.

The display unit 151 displays (outputs) information processed by the mobile terminal 100. For example, the display unit 151 can display execution screen information on the application program driven in the mobile terminal 100 or user interface (UI) information or graphic user interface (GUI) information according to the execution screen information.

In addition, the display unit 151 can be configured as a stereoscopic display unit for displaying a stereoscopic image.

A 3-dimensional display scheme such as a stereoscopic scheme (glasses type), an auto-stereoscopic scheme (glassless type), or a projection scheme (a holographic scheme) can be applied to the stereoscopic display unit.

The sound output unit 152 can output audio data received from the wireless communication unit 110 or stored in the memory 170 in a call signal reception mode, a call mode or a recording mode, a speech recognition mode, or in a broadcast reception mode. The sound output unit 152 can output a sound signal related to a function (e.g., a call signal reception sound, or a message reception sound, etc.) performed in the mobile terminal 100. This sound output unit 152 can include a receiver, a speaker, or a buzzer, etc.

The haptic module 153 can generate various tactile effects that the user can feel. A representative example of the tactile effect that is generated by the haptic module 153 can be vibration. Strength and a pattern of the vibration generated by the haptic module 153 can be controlled by user selection or setting by the control unit. For example, the haptic module 153 can output different vibrations sequentially or by synthesizing them.

Besides the vibration, the haptic module 153 can generate various tactile effects including an effect by a stimulus such as a pin array moving vertically to a contact skin surface, air jetting force or air absorptive force through an outlet or an inlet, brush against a skin surface, contact to an electrode, or static electricity, and an effect by reproducing a cold and warmth sense by using a device capable of absorbing or generating heat.

The haptic module 153 can be realized in order for the user to feel the tactile effect through a muscle sense of a finger or arm, as well as to deliver a tactile effect through a direct contact. The haptic module 153 can be provided two or more in number according to a configuration aspect of the mobile terminal 100.

The optical output unit 154 can output a signal for notifying an event occurrence by using a light from an optical source of the mobile terminal 100. The event occurred in the mobile terminal 100 can be exemplified with message reception, call signal reception, missed calls, alarm, schedule notification, email reception, or information reception through an application.

The signal output by the optical output unit 154 is implemented according to that the mobile terminal emits a monochromatic light or a multi-chromatic light toward the front or rear surface. The signal output can be completed if the mobile terminal detects that the user checks the event.

The interface unit 160 can play a role as a channel with all external devices connected to the mobile terminal 100. The interface unit 160 can receive data from the external device, receive power and transfer the power to each element inside the mobile terminal 100, or allow internal data of the mobile terminal 100 to be transmitted to the external device. For example, the interface unit 160 can include a wired/wireless headset port, an external charger port, a wired/wireless data port, a memory card port, a port for connecting a device to which an identification module is provided, an audio input/output (I/O) port, a video input/output (I/O) port, or an earphone port, etc.

Furthermore, the identification module is a chip for storing various pieces of information for authenticating user's authority for the mobile terminal 100 and can include a user identify module (UIM), a subscriber identity module (SIM), or a universal subscriber identity module (USIM). A device including the identification module (hereinafter, ‘identification device’) can be manufactured in a smart card type. Accordingly, the identification device can be connected to the mobile terminal 100 through the interface unit 160.

In addition, if the mobile terminal 100 is connected to an external cradle, the interface unit 160 can be a channel through which power is supplied from the cradle to the mobile terminal 100 or a passage through which various command signals input from the cradle by the user are delivered. The various command signals or the power input from the cradle can operate as signals for perceiving that the mobile terminal 100 is accurately mounted in the cradle.

The memory 170 can store a program for operations of the control unit 180 and temporarily store input/output data (e.g. a phone book, messages, still images, videos, etc.). The memory 170 can store data about vibrations of various patterns and sounds at the time of a touch input on the touch screen.

The memory 170 can be a storage medium including at least one of flash memory, hard disk, Solid State Disk (SSD), Silicon Disk Drive (SDD), multimedia card micro type memory, card type memory (e.g. SD or XD memory, etc.), random access memory (RAM), static random access memory (SRAM), read-only memory (ROM), electrically erasable programmable read-only memory (EEPROM), programmable read-only memory (PROM), magnetic memory, magnetic disk, and optical disc. The mobile terminal 100 can operate in relation to a web storage performing a storage function of the memory 170 over the internet.

Furthermore, as described above, the controller 180 normally controls overall operations and an operation related to an application program of the mobile terminal 100. For example, if a state of the mobile terminal satisfies a set condition, the control unit 180 executes or releases a lock state where an input of a user's control command to applications is limited.

In addition, the control unit 180 can perform a control or a process related to a voice call, data communication, or a video call, etc., or can perform a pattern recognition processing for recognizing a written input and a drawing input performed on the touch screen as a character and an image, respectively. Furthermore, the control 180 can combine and control any one of or a plurality of the above-described elements in order to implement various embodiments to be described below in the mobile terminal 100.

The power supply unit 190 receives external or internal power under a control of the control unit 180 and supplies power necessary for operating each element. The power supply unit 190 includes a battery. The battery can be an embedded battery that is rechargeable and can be detachably coupled for charging.

The power supply unit 190 can include a connection port, and the connection port can be configured as an example of the interface 160 to which an external charger providing power is electrically connected for charging the battery.

As another example, the power supply unit 190 can be configured to charge the battery in a wireless manner without using the connection port. In this case, the power supply unit 190 can receive, from an external wireless power transmitting device, power by using one or more of an inductive coupling manner on the basis of a magnetic induction phenomenon and a magnetic resonance coupling manner on the basis of an electromagnetic resonance phenomenon.

Hereinafter, various embodiments can be implemented in a recording medium that is readable with a computer or a similar device by using software, hardware, or a combination thereof.

Next, description will be provided about a communication system realizable through the mobile terminal 100 according to an embodiment.

Firstly, the communication system can use different wireless interfaces and/or a physical layer. For example, the wireless interface available by the communication system can include Frequency Division Multiple Access (FDMA), Time Division Multiple Access (TDMA), Code Division Multiple Access (CDMA), Universal Mobile Telecommunications Systems (UMTS) (in particular, Long Term Evolution (LTE), or Long Term Evolution-Advanced (LTE-A)), Global System for Mobile Communications (GSM), or etc.

Hereinafter, for convenience of explanation, description is made limitedly to CDMA. However, it is obvious that the embodiments can be applied to all communication systems including an Orthogonal Frequency Division Multiplexing (OFDM) wireless communication system as well as a CDMA wireless communication system.

The CDMA wireless communication system can include at least one terminal 100, at least one base station (BS, also can be referred to as Node B or Evolved Node B), at least one BS controller (BSC) and a mobile switching center (MSC). The MSC can be configured to be connected to the Public Switched Telephone Network (PSTN) and BSCs. The BSCs can be connected to the BS in pair through a backhaul line. The backhaul line can be provided according to at least one selected from E1/T1, ATM, IP, PPP, Frame Relay, HDSL, ADSL, and xDSL. Accordingly, the plurality of BSCs can be included in a CDMA wireless communication system.

Each of a plurality of BSs can include at least one sector, and each sector can include an omni-directional antenna or an antenna indicating a specific radial direction from the BS. In addition, each sector can include two or more antennas having various types. Each BS can be configured to support a plurality of frequency allocations and each of the plurality of allocated frequencies can have specific spectrum (e.g., 1.25 MHz, or 5 MHz).

An intersection between the sector and the frequency allocation can be called as a CDMA channel. The BS can be called as a base station transceiver subsystem (BTSs). In this case, one BSC and at least one BS are called together as a “base station”. The base station can also represent a “cell site”. In addition, each of a plurality of sectors for a specific BS can also be called as a plurality of cell sites.

A broadcasting transmitter (BT) transmits a broadcast signal to terminals 100 operated in a system. The broadcast reception module 111 illustrated in FIG. 1 is provided in the terminal 100 for receiving the broadcast signal transmitted by the BT.

Furthermore, in the CDMA wireless communication system, a global positioning system (GPS) can be linked for checking a location of the mobile terminal 100. A satellite is helpful for grasping the location of the mobile terminal. Useful location information can be obtained by less than two or at least two satellites. Here, the location of the mobile terminal 100 can be tracked by using all techniques, which are capable of tracking the location, as well as a GPS tracking technique. In addition, at least one of GPS satellites can be selectively or additionally responsible for transmitting satellite digital multimedia broadcasting (DMB).

The location information module 115 provided in the mobile terminal 100 is for detecting, operating or identifying the location of the mobile terminal 100, and can representatively include a GPS module and a WiFi module. If necessary, the location information module 115 can alternatively or additionally perform any function of other modules in the wireless communication unit 110 for obtaining data for the location of the mobile terminal 100.

The GPS module 115 can precisely calculate 3D current location information according to latitude, longitude, and altitude by calculating distance information from three or more satellites and precise time information, and by applying a trigonometry to the calculated information. A method is currently widely used that calculates location and time information using three satellites, and corrects an error in the calculated location and time information using another satellite. The GPS module 115 can calculate speed information by continuously calculating a current location in real time. However, it is difficult to precisely measure the location of the mobile terminal 100 by using the GPS module in a dead zone, such as an indoor area, of the satellite signal. Accordingly, in order to compensate for location measurement in the GPS manner, a WiFi positioning system (WPS) can be used.

The WPS is a technique for tracking the location of the mobile terminal 100 using a WiFi module provided in the mobile terminal 100 and a wireless access point (AP) transmitting or receiving a wireless signal to or from the WiFi module, and can mean a location measurement technique based on a wireless local area network (WLAN) using WiFi.

The WPS can include a WiFi positioning server, the mobile terminal 100, a wireless AP connected to the mobile terminal 100, and a database for storing arbitrary wireless AP information.

The mobile terminal 100 connected to the wireless AP can transmit a location information request message to the WiFi positioning server.

The WiFi positioning server extracts information on the wireless AP connected to the mobile terminal 100 on the basis of the location information request message (or a signal) of the mobile terminal 100. The information on the wireless AP connected to the mobile terminal 100 can be transmitted to the WiFi positioning server through the mobile terminal 100 or transmitted to the WiFi positioning server from the wireless AP.

The information on the wireless AP, which is extracted on the basis of the location information request message of the mobile terminal 100, can be at least one selected from a MAC address, a Service Set Identification (SSID), a Received Signal Strength Indicator (RSSI), Reference Signal Received Power (RSRP), Reference Signal Received Quality (RSRQ), channel information, Privacy, a Network Type, Signal Strength, and Noise Strength.

As described above, the WiFi positioning server can receive information on the wireless AP connected to the mobile terminal 100, and extract wireless AP information corresponding to the wireless AP to which the mobile terminal is being connected from the pre-constructed database. At this point, information on arbitrary wireless APs, which is stored in the database, can be information on a MAC Address, an SSID, channel information, Privacy, a Network Type, latitudinal and longitudinal coordinates of a wireless AP, a building name and floor on which the wireless AP is located, indoor detailed location information (GPS coordinates available), an address of an owner of the wireless AP, a phone number, and etc. At this point, in order to remove a wireless AP provided by using a mobile AP or an illegal MAC address in the location measurement process, the WiFi positioning server can extract a prescribed number of pieces of wireless AP information in the descending order of an RSSI.

Thereafter, the WiFi positioning server can extract (or analyze) location information on the mobile terminal 100 by using at least one piece of wireless AP information extracted from the database. The location information of the mobile terminal 100 is extracted (or analyzed) by comparing the stored and the received wireless AP information.

As a method of extracting (or analyzing) location information on the mobile terminal 100, a cell-ID method, a fingerprint method, a trigonometry, and a landmark method can be used.

The cell-ID method is a method of determining a location of a wireless AP having strongest strength from among surrounding wireless AP information collected by a mobile terminal. This method is advantageous in that implementation is easy, an additional cost is not necessary, and location information can be rapidly obtained. However, if installation intensity of a wireless AP is lower, positioning precision becomes lowered.

The fingerprint method is a method of selecting a reference location in a service area, collecting signal strength information, and estimating a location through signal strength information transmitted from a mobile terminal on the basis of the collected information. In order to use the fingerprint method, it is necessary to construct a database for propagation characteristics in advance.

The trigonometry is a method of operating a location of a mobile terminal on the basis of a distance between coordinates of at least three wireless APs and the mobile terminal. For estimating the distances between the mobile terminal and the wireless APs, signal strength is converted into distance information, or a time of arrival (ToA) of a wireless signal, a time difference of arrival (TDoA) of a wireless signal, an angle of arrival (AoA) of a wireless signal can be used.

The landmark method is a method of measuring a location of a mobile terminal by using a landmark transmitter.

Besides the above-described methods, various algorithms can be used for extracting (or analyzing) location information on a mobile terminal.

The location information on the mobile terminal 100 extracted in this way can be transmitted to the mobile terminal 100 through the WiFi positioning server and the mobile terminal 100 can obtain the location information.

The mobile terminal 100 can be connected to at least one wireless AP to obtain location information. At this point, the number of wireless APs requested for obtaining the location information on the mobile terminal 100 can be diversely varied according to a wireless communication environment in which the mobile terminal 100 is located.

Next, a description will be provided about an operation method of a mobile terminal according to an embodiment.

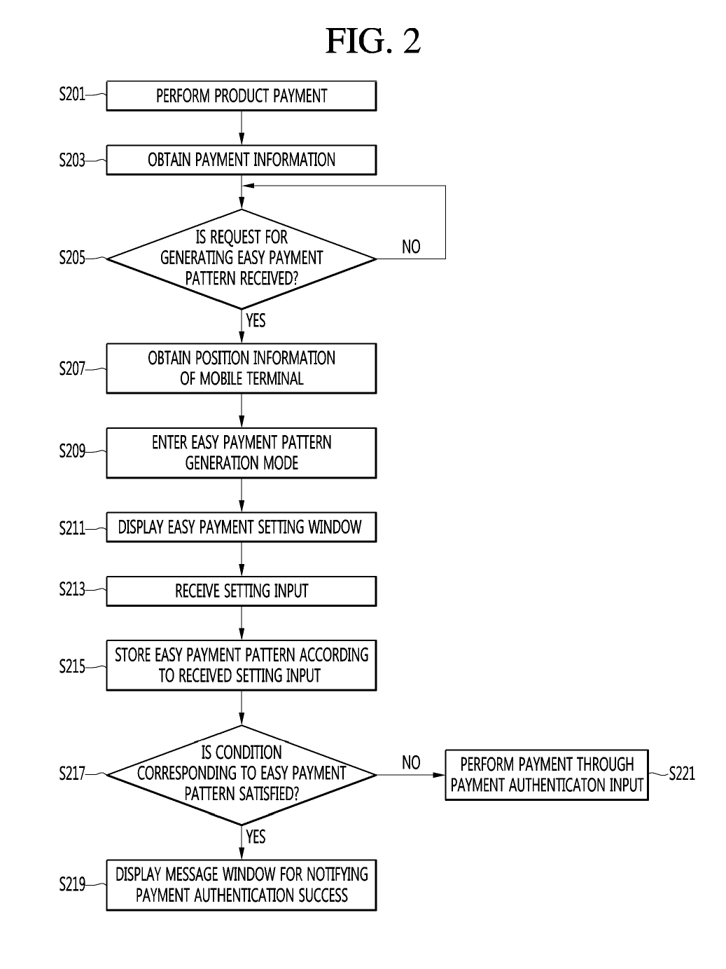

FIG. 2 is a flowchart illustrating an operation method of a mobile terminal according to an embodiment.

The control unit 180 of the mobile terminal 100 performs product payment (operation S201). The control unit 180 can communicate with a point of sale (POS) terminal to transmit card information and can perform product payment on the basis of the transmitted card information.

In an embodiment, the control unit 180 can perform product payment in a magnetic secure transmission (MST) scheme.

In another embodiment, the control unit 180 can perform product payment by using a short range wireless communication method. The control unit 180 can perform payment by transmitting information on a card to a payment terminal through a short range communication module 114 provided in the mobile terminal 100. The short range communication module 114 can be a near field communication (NFC) module, which is just an example, and various types of short range communication modules can be used. To this end, the payment terminal can also include an NFC module.

In an embodiment, the control unit 180 can receive a user's fingerprint to succeed in authentication and then can perform product payment.

In another embodiment, the control unit 180 can receive a password to succeed in authentication and then can perform product payment.

The control unit 180 obtains payment information related to the performed product payment (operation S203). In an embodiment, the payment information can include one or more of a product payment time, a payment amount, and a payment place. The control unit 180 can store the obtained payment information in a memory 170. The control unit 180 can display the payment information through the display unit 151 after the product payment. The payment information can be received from the payment terminal.

The control unit 180 can display information for notifying that the easy payment pattern is possibly generated on the basis of the obtained payment information. The control unit 180 can display information for notifying that the easy payment pattern is possibly generated, after the product payment.

In an embodiment, the control unit 180 can display information for indicating that easy payment information is possibly generated if a product is initially paid in a specific shop.

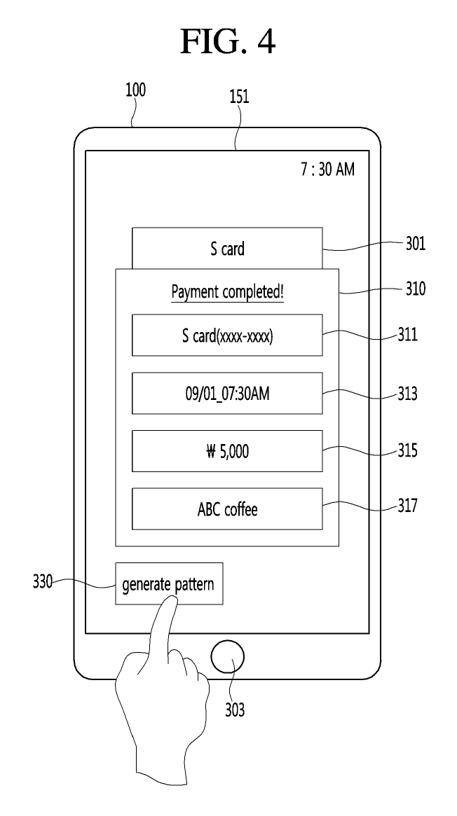

In another embodiment, the control unit 180 can display information for notifying that an easy payment pattern is possibly generated if payments are performed the prescribed number of times in a specific shop at a specific time period. The information for notifying that the easy payment pattern is possibly generated can include a pattern generation item (illustrated in FIG. 4). For example, if the product payment is performed ten times or more in a specific shop for 30 days, from 7 am till 8 am, the control unit 180 can display the pattern generation item. The control unit 180 can display an additional notice for indicating that the easy payment pattern is possibly generated. The control unit 180 can display an easy payment pattern generation window to be described later, if a request for selecting the pattern generation item is received.

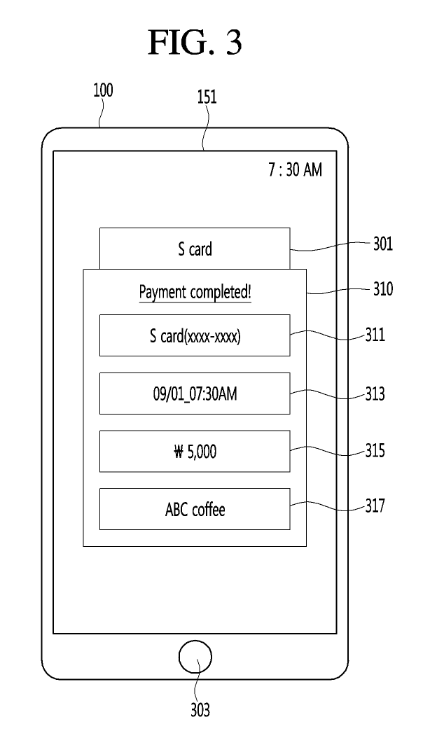

Operation S201 to operation S203 will be described with reference to FIG. 3.

FIG. 3 illustrates a state where the product payment is performed by using a mobile terminal according to an embodiment, and FIG. 4 illustrated a process for receiving a request for generating an easy payment pattern according to an embodiment.

Referring to FIG. 3, the control unit 180 can display a card image 301 on a display 151 according to an input for providing the card image 301 corresponding to a pre-registered card. The user can input a fingerprint to a fingerprint recognition unit 303 to pay for a product through the card image 301. After the product payment is performed, the control unit 180 can obtain payment information 310 related to the product payment and display the obtained payment information 310 through the display unit 151. The payment information 310 can include card identification information 311 for identifying a card, a payment time 313, a payment amount 315, and the name of a product selling shop 317. The card identification information 311 can include one or more of a card name and a card identification number.

On the other hand, as illustrated in FIG. 4, the control unit 180 can further display a pattern generation item 330 for requesting the easy payment pattern generation through the display unit 151. In an embodiment, the control unit 180 can display the pattern generation item 330 after the product payment is performed. In another embodiment, the control unit 180 can display the pattern generation item 330 after first payment is performed in a specific shop. In still another embodiment, the control unit 180 can display the pattern generation item 330 if payments are performed the prescribed number of times in a specific shop at a specific time period.

The control unit 180 can allow a mode of the mobile terminal 100 to enter an easy payment pattern generation mode according to reception of a request for selecting the pattern generation item 330.

A description is provided with reference to FIG. 2 again.

The control unit 180 checks whether the request for easy payment pattern generation is received (operation S205), and if the request for easy payment pattern generation is received, obtains the location information of the mobile terminal 100 (operation S207). In an embodiment, the request for easy payment pattern generation can be the request for selecting the pattern generation item.

In an embodiment, the control unit 180 can receive the request for easy payment pattern generation and at the same time, obtain the location information of the mobile terminal 100. The control unit 180 can obtain information on a current location of the mobile terminal 100 by using a location information module 115 according to reception of the request for easy payment pattern generation. The location information module 115 can be any one of a GPS module or WiFi module. The control unit 180 can activate an operation of the location information module 115 provided in the mobile terminal to obtain the location information of the mobile terminal 100 according to reception of the request for easy payment pattern generation. The activation of the operation of location information module 115 can indicate that power is applied to the location information module 115 to turn on the operation of the location information module 115. The control unit 180 can also display an icon for indicating the activation of the location information module 115 on the display unit 151.

The obtained location information can be used for generating the easy payment pattern to be described later.

The control unit 180 allows the mobile terminal 100 to enter the easy payment pattern generation mode according to the received request (operation S209), and displays an easy payment pattern generation window (operation S211). In an embodiment, the easy payment pattern generation mode can be a mode for generating a payment pattern for enabling product payment to be automatically performed without authentication such as a fingerprint input in a shop frequently visited by the user. After the easy payment pattern is generated, if a condition corresponding to the easy payment pattern is satisfied, the user can easily pay for a product without additional authentication such as fingerprint recognition.

In an embodiment, the easy payment pattern generation window can include a plurality of items for generating the easy payment pattern. The plurality of items can include one or more of time, location, payment amount, and security level items. A description thereabout will be provided later.

The control unit 180 receives a setting input for each of a plurality of items included in the easy payment setting window (operation S213) and stores the easy payment pattern generated according to the received setting input (operation S215). In an embodiment, the easy payment pattern can be a pattern to be a reference for automatically performing product payment without additional fingerprint authentication or password input, if the user visits a specific shop at a specific time period and pays a payment amount within a certain range. The easy payment pattern can include a specific time range, a specific location range, and a payment amount range according to the setting input.

The control unit 180 checks whether a condition corresponding to the stored easy payment pattern is satisfied (operation S217), and if the easy payment condition is satisfied, automatically performs product payment (operation S219). The control unit 180 can determine whether the easy payment condition is satisfied on the basis of one or more of the time range, the specific location range, and the payment amount rage, included in the easy payment pattern.

On the other hand, if the easy payment condition is not satisfied, the control unit 180 performs product payment through a payment input (operation S221).

Operations S209 to S221 will be described in detail with reference to the following drawings.

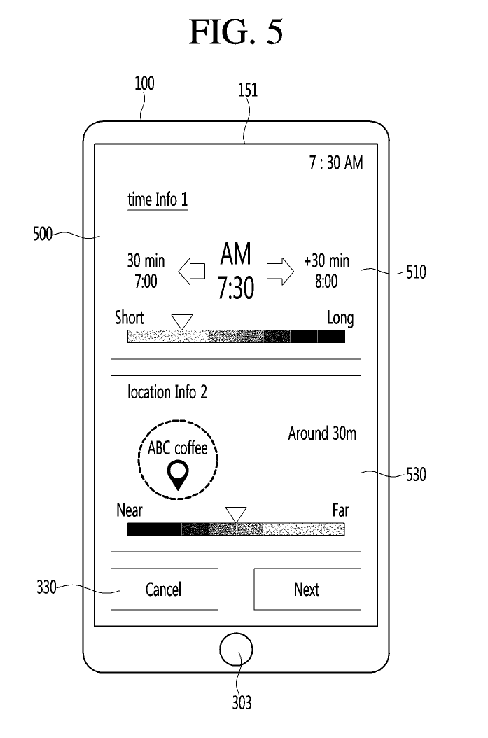

FIGS. 5 to 10 illustrate examples for generating an easy payment setting window and generating an easy payment pattern through the easy payment setting window according to an embodiment.

The control unit 180 can display an easy payment setting window 500 according to the request for easy payment pattern generation.

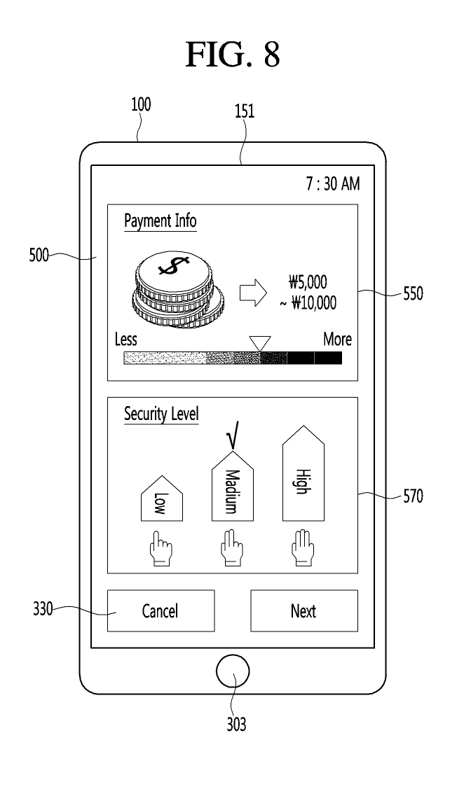

The easy payment setting window 500 can include one or more of a time item 510, a location item 530, a payment amount item 550, and a security level item 570. In FIG. 5, the time item 510 and the location item 530 are illustrated and in FIG. 8, the payment amount item 550 and the security level item 570 are illustrated.

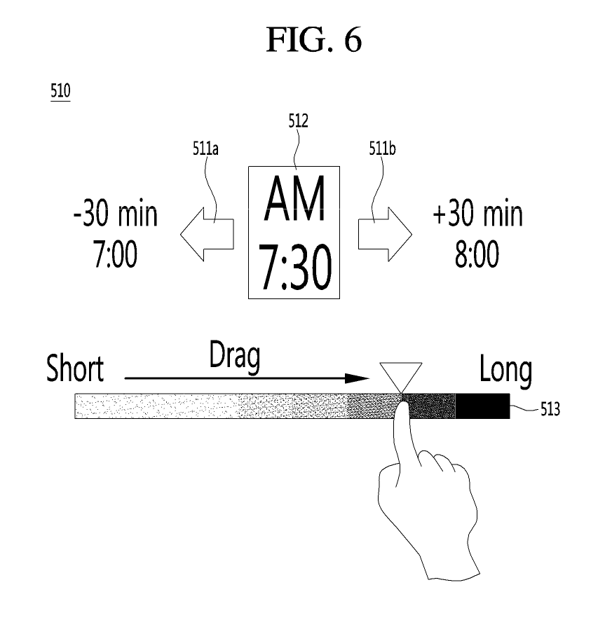

The time item 510 can be an item for setting a time period at which the shop can be visited. The time item 510 can be an item for setting a time period at which the user can visit the shop on the basis of the payment time included in the payment information 310 obtained in relation to FIG. 3. Referring to FIGS. 5 and 6, the time item 510 can include one or more of buttons 511a and 511b and a slide bar 513 for setting the time range on the basis of 7:30 am, which is the obtained payment time. The button 511a is to set a reduced time on the basis of 7:30 am and the button 511b is to set an increased time on the basis of 7:30 am. The control unit 180 can adjust the time range according to reception of an input for dragging a point on the slide bar 513. The user drags a point on the slice bar 513 to the right to expand the time range and to the left to contract the time range on the basis of the reference time 512.

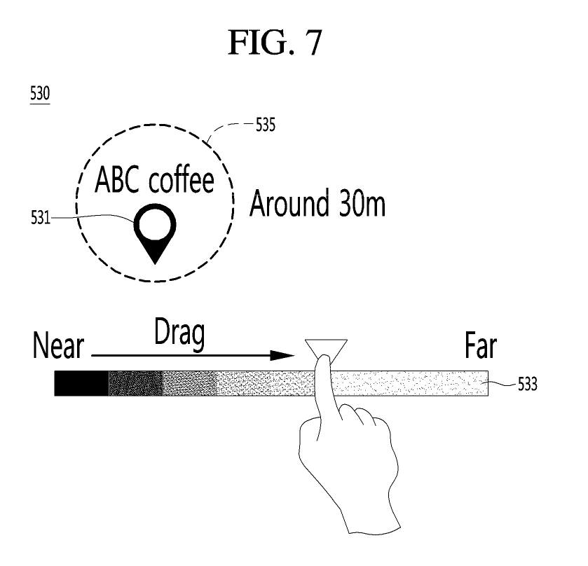

The location item 530 can be an item for setting a location area spaced apart by a certain distance from a specific location on the basis of the specific location. The location item 530 can be an item for setting a location range spaced apart from the specific location (e.g. location of ABC coffee shop) included in the payment information 310 obtained in relation to FIG. 3. Referring to FIGS. 5 and 7, the location item 530 can include a slide bar 533 for setting a location range on the basis of an obtained location 531. The control unit 180 can adjust the location range according to reception of an input for dragging a point on the slide bar 513. For example, the control unit 180 can expand a corresponding location area 535 within a certain distance on the basis of the reference location 531 according to an input for dragging a point on the slide bar 533 to the right, and can contract the corresponding location area 535 within the certain distance on the basis of the reference location 531 according to an input for dragging a point on the slide bar 533 to the left.

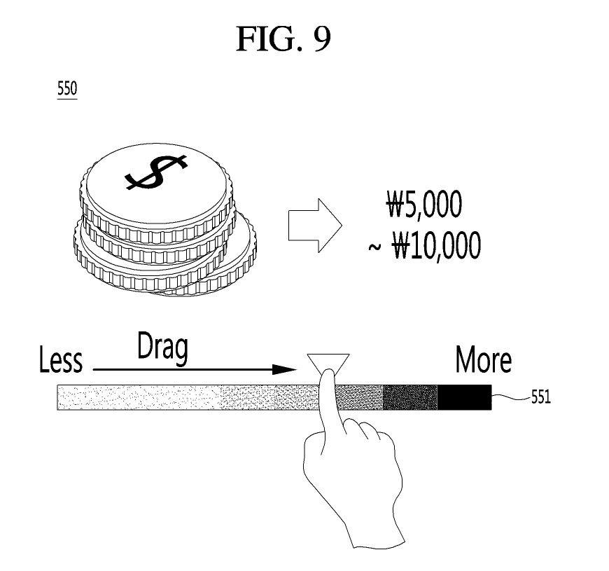

The payment amount item 550 can be an item for setting a payment amount within a certain range on the basis of a specific amount. The payment amount item 550 can be an item for setting a certain amount range on the basis of the payment amount included in the payment information 310 obtained in relation to FIG. 3. Referring to FIGS. 8 and 9, the payment amount item 550 can be an item for setting the payment amount within a certain range on the basis of the obtained payment amount (e.g. 5,000 won). For example, the control unit 180 can expand the payment amount range on the basis of a reference amount according to an input for dragging a point on the slide bar 551 to the right, and contract the payment amount range on the basis of the reference amount according to an input for dragging a point on the slide bar 551 to the left.

The security level item 570 can be an item for setting a security level for easy payment authentication, if the easy payment condition is satisfied. The security level item 570 can be an item for performing the easy payment authentication on the basis of a movement input on a touch point. Referring to FIG. 8, a first security level, which is a Low level, can be correspond to an input for moving one touch point in a specific direction with one finger. A second security level, which is a Medium level, can correspond to an input for moving two touch points in a specific direction with two fingers. A third security level, which is a High level, can correspond to an input for moving three touch points in a specific direction with three fingers. The security level item 570 can also be omitted.

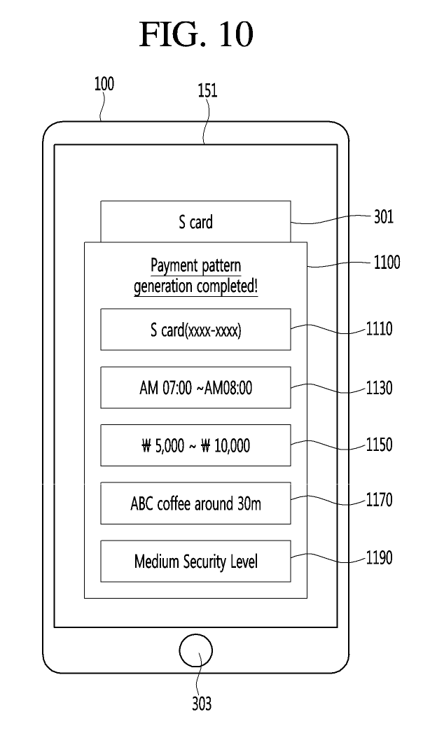

Through the processes illustrated in FIGS. 5 to 9, if settings for the time item 510, the location item 530, and the payment amount item 550 are completed, the control unit 180 can generate the easy payment pattern according to the setting result. If the settings are completed, the control unit 180 can display the generated easy payment pattern 1100 through the display unit 151 as illustrated in FIG. 10. The easy payment pattern 1100 can include one or more of a card item 1110, a time range item 1130, a payment amount range item 1150, a location range item 1170, and a security level identification item 1190.

The card item 1110 can include information on a card for easy payment. The card item 1110 can include information corresponding to a card, which is included in the payment information 310 obtained in relation to FIG. 3, but is not limited thereto. The card item 1110 can include information on a card, which is a basis for generating the easy payment pattern. In other words, the information on the card, which is a basis for generating the easy payment pattern, can include card identification information 311 included in the payment information 310 described in relation to FIG. 3.

The time range item 113 is an item including a specific time range generated on the basis of a setting input for the time item 510 described in relation to FIGS. 5 and 6. In FIG. 10, the time range item 1130 is set to be from 7 am to 8 am.

The payment amount range item 1150 is an item including a specific amount range generated on the basis of a setting input for the payment amount item 550 described in relation to FIGS. 8 and 9. In FIG. 10, the payment amount range item 1150 is set to be from 5,000 won to 10,000 won.

The location range item 1170 is an item including a specific location range generated on the basis of a setting input for the location item 530 described in relation to FIGS. 5 and 7. In FIG. 10, the location range item 1170 is set to be within 30 m from a reference location.

The security level identification item 1190 is an item for requesting a specific security level generated on the basis of a setting input for the security level item 570 described in relation to FIG. 8. In FIG. 10, the security level identification item 1190 is set to be the second security level, which is a Medium level.

If the easy payment condition corresponding to the easy payment pattern 1100 is satisfied, the control unit 180 can automatically perform product payment without additional authentication such as a password input.

In an embodiment, the easy payment condition can be satisfied, if a current time is within a time range corresponding to the time range item 1130 and a current location of the mobile terminal 100 is within a location range corresponding to the location range item 1170. For example, if the current time is 7:45 am and the current location of the mobile terminal 100 is spaced apart by 1 m from the reference location, the control unit 180 can determine that the easy payment condition is satisfied.

In another embodiment, the easy payment condition can be satisfied, if a current time is within a time range corresponding to the time range item 1130, a current location of the mobile terminal 100 is within a location range corresponding to the location range item 1170, and a payment planned amount is within a payment amount range corresponding to the payment range item 1150. For example, if the current time is 7:45 am, the current location of the mobile terminal 100 is spaced apart by 1 m from the reference location, and the payment planned amount is 7,000 won, the control unit 180 can determine that the easy payment condition is satisfied. In order to check whether the easy payment condition is satisfied, the control unit 180 can receive information on the payment planned amount in advance from a payment terminal.

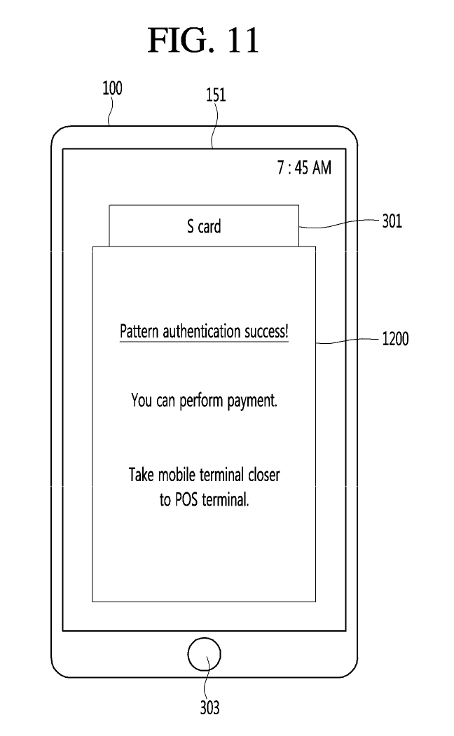

FIG. 11 illustrates that payment authentication is completed if an easy payment condition is satisfied according to an embodiment.

If the easy payment condition is satisfied, the control unit 180 can display a message window 1200 for notifying payment authentication success as illustrated in FIG. 11. In other words, if the easy payment condition is satisfied, the control unit 180 can determine completion of product payment authentication and display the message window 1200 for notifying payment authentication success. The message window 1200 can include information for notifying that the authentication according to the easy payment pattern is completed and that payment is possible. In addition, the message window 1200 can include guide information for guiding the user to take the mobile terminal 100 closer to the payment terminal. Accordingly, the user can easily perform the product payment without additional input such as a fingerprint input or password input for product payment authentication.

On the other hand, according to still another embodiment, the easy payment condition can be satisfied if an input corresponding to a security level is to be received other than the time range, location range, and payment amount range.

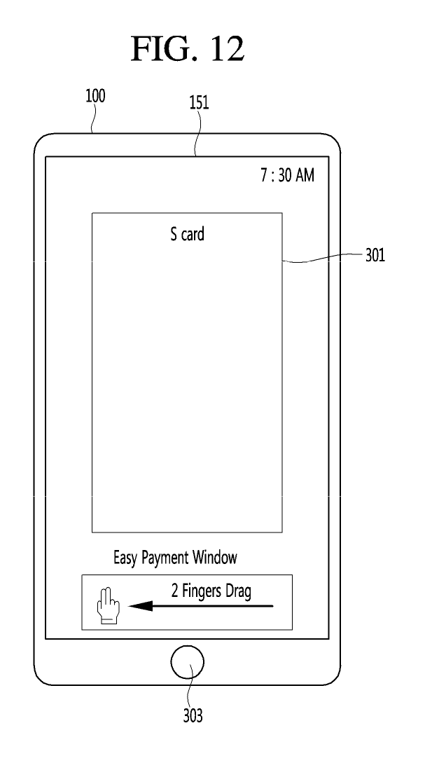

FIG. 12 illustrated a process for receiving an input corresponding to a security level set for easy payment according to an embodiment.

In still another embodiment, the easy payment condition can be satisfied, if a current time is within a time range corresponding to the time range item 1130, a current location of the mobile terminal 100 is within a location range corresponding to the location range item 1170, a payment planned amount is within a payment amount range corresponding to the payment range item 1150, and an input corresponding to the security level is received. For example, if the current time is 7:45 am, the current location of the mobile terminal 100 is spaced apart by 1 m from the reference location, the payment planned amount is 7,000 won, and an input is received for dragging two touch points corresponding to the second security level, the control unit 180 can determine that the easy payment condition is satisfied. Accordingly, the control unit 180 can display the message window 1200 as illustrated in FIG. 11. The user can flexibly set the security level corresponding to the easy payment pattern, and perform easy payment through an easy gesture input without a cumbersome procedure.

According to an embodiment, the user can easily pay for a product with a mobile terminal without an additional input such as a fingerprint input or password input, if purchasing the product in a frequently visiting shop.

The embodiments can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices, and carrier waves (such as data transmission through the Internet). In addition, the computer can also include the control unit 180 of the terminal.

According to at least one of embodiments of the present disclosure, a user can easily pay for products in a frequently visiting shop without an additional authentication process.

In addition, limitations of an existing fragmentary and cumbersome method can be solved by applying a user payment pattern based on location information to a spreading mobile payment system.

Embodiments provide a mobile terminal and an operation method thereof for solving the above and other limitations.

Embodiments also provide a mobile terminal and an operation method thereof capable of easily paying for products without an additional authentication process.

Embodiments also provide a mobile terminal and an operation method thereof capable of generating easy payment information on the basis of user's payment pattern, and easily paying without additional authentication process if a condition corresponding to the easy payment information is satisfied.

In one embodiment, a mobile terminal includes: a display unit: a wireless communication unit to exchange information on payment for a product with a payment terminal; a memory to store the information on the payment; and a control unit coupled with the display unit, the wires communication unit and the memory, wherein the control unit is further capable of displaying information for indicating completion of payment authentication for the product, if a condition corresponding to easy payment information includes a time range and a location range.

The control unit may display information for indicating the completion of payment authentication for the product, if a current time is in the time range and a current location of the mobile terminal is in the location range.

The easy payment information may further include a payment amount range, wherein if a payment amount for the product is in the payment amount range, the control unit displays information for indicating completion of the payment authentication for the product.

The easy payment information may further include a security level identification item, wherein if an input corresponding to the security level identification item is received, the control unit may display information for indicating completion of payment authentication for the product.

The control unit may receive setting inputs for the time range, the location range, a payment amount range, and a security level, which correspond to the easy payment information, and store the easy payment information according to the received setting inputs in the memory.

The easy payment information may be generated on a basis of obtained payment information, if a product is paid in a prescribed shop.

The control unit may display information for representing that the easy payment information is generated, if the product is initially paid in a prescribed shop.

The control unit may display information for representing that the easy payment information is generated, if payment is performed a prescribed number of times or more at a prescribed time period in a prescribed shop.

The control unit may display information for requesting authentication for product payment, if a condition corresponding to the easy payment information is not satisfied.

In another embodiment, an operation method of a mobile terminal, includes: receiving an input for setting easy payment information, which includes a time range and a location range; storing the easy payment information generated according to a received input; and displaying information for representing completion of payment authentication for a product, if a condition corresponding to the easy payment information is satisfied.

The details of one or more embodiments are set forth in the accompanying drawings and the description below. Other features will be apparent from the description and drawings, and from the claims.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A mobile terminal comprising:
a display:
a wireless communication unit to exchange information with a payment terminal regarding product payment;
a memory to store the information regarding the product payment; and
a controller coupled to the display, the wireless communication unit and the memory, wherein the controller is configured to:
determine that a condition is satisfied based on easy payment information that includes a time range and a location range; and
display information for indicating completion of payment authentication for the product, when the condition is determined to be satisfied.

2. The mobile terminal according to claim 1, wherein the controller displays information for indicating the completion of payment authentication for the product, when a current time is within the time range and a current location of the mobile terminal is within the location range.

3. The mobile terminal according to claim 2, wherein the easy payment information includes a payment amount range,
wherein when a payment amount for the product is within the payment amount range, the controller displays information for indicating completion of the payment authentication for the product.

4. The mobile terminal according to claim 3, wherein the easy payment information includes a security level identification item,
wherein in response to receiving an input corresponding to the security level identification item, the controller displays information for indicating completion of payment authentication for the product.

5. The mobile terminal according to claim 1, wherein the controller receives setting inputs corresponding to the easy payment information, and the controller stores, in the memory, the easy payment information according to the received setting inputs, the setting inputs being for the time range, the location range, a payment amount range, and a security level.

6. The mobile terminal according to claim 5, wherein the easy payment information is provided based on obtained payment information, when a product is purchased at a specific location.

7. The mobile terminal according to claim 1, wherein the controller displays information for indicating that the easy payment information is provided when the product is initially purchased at a specific location.

8. The mobile terminal according to claim 1, wherein the controller displays information for indicating that the easy payment information is provided, when payment is performed at least a prescribed number of times at a prescribed time period at a specific location.

9. The mobile terminal according to claim 1, wherein when a condition fails to be satisfied, the controller displays information for requesting authentication for product payment.

10. An operation method of a mobile terminal, the method comprising:
receiving an input for setting easy payment information that includes a time range and a location range;
storing the easy payment information;
determining that a condition is satisfied based on the easy payment information; and
displaying information for indicating completion of payment authentication for a product, when the condition is determined to be satisfied.

11. The operation method according to claim 10, wherein the displaying of the information includes displaying information for indicating the completion of payment authentication for the product, when a current time is within the time range and a current location of the mobile terminal is within the location range.

12. The operation method according to claim 11, wherein the easy payment information includes a payment amount range,
wherein when a payment amount of the product is within the payment amount range, the displaying of the information includes displaying information for indicating the completion of payment authentication for the product.

13. The operation method according to claim 12, wherein the easy payment information includes a security level identification item,
wherein in response to receiving an input corresponding to the security level identification item, the displaying of the information includes displaying information for indicating the completion of payment authentication for the product.

14. The operation method according to claim 10, wherein the easy payment information is based on obtained payment information, when a product is purchased at a specific location.

15. The operation method according to claim 10, further comprising:
displaying information for requesting authentication for product payment, when the condition corresponding to the easy payment information is not satisfied.

16. A mobile terminal comprising:
a display:
a wireless communication unit to exchange information with a terminal; and
a controller configured to:
store payment information that includes at least a time range and a location range,
determine that a condition of the payment information is satisfied, and
display information indicating payment success based on the determined condition of the payment information.

17. The mobile terminal according to claim 16, wherein the controller displays information indicating payment success, when a current time is within the time range and a current location of the mobile terminal is within the location range.

18. The mobile terminal according to claim 16, wherein the payment information includes a payment amount range,
wherein when a payment amount for the product is within the payment amount range, the controller displays information indicating payment success.

19. The mobile terminal according to claim 16, wherein the payment information includes a security level identification item,
wherein in response to receiving an input corresponding to the security level identification item, the controller displays information indicating payment success.

20. The mobile terminal according to claim 16, wherein the controller receives setting inputs corresponding to the payment information, and the controller stores the payment information according to the received setting inputs, the setting inputs being for the time range, the location range, a payment amount range, and a security level.
